(19) United States
(12) Patent Application Publication
(10) Pub. No.: US 2004/0088915 A1
(43) Pub. Date: May 13, 2004

(54) Shaping guide

(76) Inventor: Rod Power, Greennale (AU)

Correspondence Address: The Halvorson Law Firm, Ste 1, 405 W. Southern Ave., Tempe, AZ, 85282, US

(21) Appl. No.: 10/672,049

(22) Filed: Sep. 26, 2003

(30) Foreign Application Priority Data
Sep. 30, 2002 (AU) 2002951726

(51) Int. Cl. A01G 1/00; A01G 17/14

(52) U.S. Cl. 47/42; 47/44

(57) ABSTRACT

Described is a tree or shrub shaping guide comprising at least one elongated support positionable adjacent an object to be shaped; at least one shaped guide; and a connection mechanism connecting the shaped guide to the at least one elongated support, which comprises movement elements to allow the shaped guide to move relative to the at least one elongated support; wherein the at least one shaped guide allows movement along a shaped path and enables a user to operate a cutting mechanism to shape an object such as a tree or shrub.

This application is a continuation of pending Australian Provisional Application Serial No. 2002951726, filed on Sep. 30, 2002.

### FIELD OF THE INVENTION

The present invention relates to tree or shrub shaping aids and more particularly relates to a tree or shrub shaping guide which can be employed to enable a user to operate a shaping tool or secateurs or the like to shape a tree or shrub. It is particularly related to guiding the user in the art of topiary but is not limited to such field.

### BACKGROUND ART

The use of some forms of shaping aids is known in the prior art. More specifically known but not generally or well-known shaping aids can be categorised into two types. These aids have been located by a search of patent documents and are not considered common general knowledge. However, they are referred to in order to assist in more clearly defining the present invention. The first category of shaping aids is the creation of a mould or frame to define a required shape. The second is a means of holding heavy duty motorised cutting equipment in trimming procedures.

In U.S. Pat. No. 3,992,812 there is disclosed a topiary shaping frame comprising a three-dimensional framework which corresponds with the required final shape for use as a cutting and trimming guide in shaping plants into artistic form or topiaries. The supporting framework is provided with anchoring means permitting, use in small sizes, with potted plants, and, in larger sizes, with outdoor landscape plantings. In larger sizes, the framework is vertically separable into half portions permitting removal from a planting for re-use.

U.S. Pat. No. 4,190,984 discloses a method for constructing a shrubbery shaper for shaping plants and shrubs into a desired three dimensional form which includes the steps of tracing a suitable pattern in the configuration of an object which will form the shape of the shrubbery shaper; cutting a quantity of open mesh wire to a selected width and length to form a frame; shaping the open mesh wire into the pattern configuration; shaping side panels in the pattern configuration for attachment to the frame; planting suitable shrubbery at a selected location and spacing; and placing the shrubbery shaper over the planted shrubbery and securing it to the ground.

In U.S. Pat. No. 4,258,503 there is disclosed a three dimensional topiary figure and method of making the same. The topiary figure includes a first and-second skeletal-member of a predetermined compatible shape joined together to produce an assembled, unitary, three dimensional shape typically in the shape of an animal or geometric design.

Therefore this category of shaping aids must be in the final shape of the required tree or shrub shape. It is not useable in any other procedure or for different size plants and is not useable in creative designs. Further the shape generally remains with the plant and cannot be reused.

In the second category of shaping aids the cutting equipment is mounted on heavy-duty vehicles. However, this equipment is of large cutting means for use on tractors or the like.

In GB patent application 2,160,404 for example there is disclosed an agricultural tractor provided with a front loader that has a side working implement such as a hedge cutter or rotary mower mounted directly on the front loader frame at a position in the centre section of the tractor.

Also GB patent application 2,008,918 discloses a tractor-mounted hedge-cutter or like machine in which a work-head (1) provided with a hydraulically driven rotary cutter is mounted on the outer end of an articulated, laterally extending boom (3, 6) of which the inner section (6) is pivotally mounted at its inner end on a frame (9) attached to the tractor, cooling of the oil in the hydraulic driving system for the rotary cutter is effected by passing the oil returning from a hydraulic driving motor (2) mounted on the work-head, first through a blister or cavity (28) provided in the cutter hood or guard (29) and then through the hollow interior of the boom section (6) to a storage tank (10) mounted on the frame

None of these allow a user to design and create a topiary figure without being limited to the frame shape that must be retained with the plant or without use of heavy equipment. Further the heavy equipment is not particularly accurate for topiary or available to most people.

It is therefore an object of the invention to provide an improved shaping guide, which is useable by a single person and overcomes or at least ameliorates one or more of the problems of the prior art.

In particular it is an object of the invention to provide a shaping guide, which allows design and creation of works of topiary. In this regard non linear lines are required.

Therefore, it can be appreciated that there exists a continuing need for a new and improved shaping guide which can be employed to guide in performing neat tree or shrub shaping particularly in circumstances wherein the topiary is required to be shaped along a curved path. In this regard, the present invention substantially fulfils this need.

### SUMMARY OF THE INVENTION

In accordance with the invention there is provided a tree or shrub shaping guide including a support able to be positioned adjacent a tree or shrub to be shaped; a shaped guide; and a connection mechanism connecting the shaped guide to the elongated support and including movement elements to allow the shaped guide to move relative to the support; wherein the shaped guide follows a shaped path around the tree or shrub which can be employed to enable a user to operate a shaping blade or secateurs or the like to shape a tree or shrub and particularly for guiding the user in the art of topiary.

The support can include an elongated telescopic post with the shaped guide mounted on or near the top for adjusting the height of the guide dependent on the height of the tree or shrub. The elongated support can be mounted on a stand to enable steady unassisted location of the guide adjacent the tree or shrub. The stand includes movement mechanisms such as wheels allowing for ready movement to a new location or different part of the tree or shrub or to adjacent tree or shrub so the same design can be applied consistently.

The shaped guide includes at least one elongated shaped member having at least a curved portion; and the connection mechanism including said movement elements allowing sliding or pivotal movement relative to the posts such that the shaped guide including the curved portion follows a shaped path. The elongated shaped member forms a partial circumference of a sphere and the connection mechanism including said movement elements allowing sliding or pivotal movement relative to the posts such that the shaped guide follows a substantially spherical shaped path. The shaped guide includes at least one exoskeletal shaped member forming a portion of the required shape of the tree or shrub and the connection mechanism of the shaped member to the support including said movement elements allowing sliding or pivotal movement relative to the support such that the shaped guide allows shaping of more than one portion of the tree or shrub than the shaped member covers in one position.

The shaped guide can include a plurality of comb-like slits to allow the shaped guide to follow a shaped path with parts of the tree or shrub to protrude through the slits and allow trimming thereof to shape the tree or shrub to the shaped path.

A plurality of the elongated shaped members can be mounted on the support and positionable adjacent the tree or bush and the elongated shaped members movable relative to the support around the tree or bush by said movement elements of the connection mechanism to spaced positions to form an enclosing exoskeletal partial circumference of a shape and allowing a trimming of the tree or bush between the plurality of the elongated shaped members to form the virtual shape defined by the elongated shaped members.

The tree or shrub shaping guide can have the shaped guide mounted on the support with the connection mechanism including movement elements allowing rotational movement relative to the support such that the shaped guide follows a curved path allowing shaping of more than one portion of the tree or shrub than the shaped member covers in one position.

A cutting mechanism such as an electric trimmer or the like can be mounted on the shaped guide and able to slide along or move relative to the guide to fulfil the required shaped cut on the tree or shrub.

The invention also provides a tree or shrub shaping guide including an elongated support having two spaced posts each with elongated linear foot which forms an inverted T shape, the posts being telescopic and able to be positioned adjacent a tree or shrub to be shaped and having cross member between the posts for strength, the cross member further including a restraint mechanism in the form of a tie or loop and hook material such as known under the Velcro name and said restraint mechanism being substantially central such that it can fit around and be restrained at the trunk of a tree to be shaped; a shaped substantially semi-circular curved guide mounted by a connection mechanism connecting the shaped guide to the top of the elongated posts and including movement elements to allow the shaped guide to move pivotally relative to the elongated support such that the shaped curve follows a ball shape around the tree or shrub, which can be employed to enable a user to operate a cutting means or secateurs or the like to shape a tree or shrub and particularly for guiding the user in the art of topiary.

Also the invention provides a tree or shrub shaping guide including a support able to be positioned adjacent a tree or shrub to be shaped; one or more shaped guides; and a connection mechanism connecting the shaped guides to the support; wherein by the combination of various shaped guides connected to the support a shaped path is defined around the tree or shrub, which can be employed to enable a user to operate a shaping blade or secateurs or the like to shape a tree or shrub and particularly for guiding the user in the art of topiary.

The connection mechanism in one form can allow releasable connection of the one or more shaped guides. The connection mechanism can allow releasable simultaneous connection of a plurality of the shaped guides. Preferably the connection mechanism allows separate movement of the plurality of the shaped guides. The connection mechanism with movement elements allowing separate movement of the plurality of the shaped guides allows a combination of various shaped guides and various movement elements and or movement elements to define a three dimensional shape.

The support can include an elongated telescopic post with the shaped guide mounted on or near the top for adjusting the height of the guide dependent on the height of the tree or shrub. The elongated support can be mounted on a stand to- enable steady unassisted location of the guide adjacent the tree or shrub. The stand including movement mechanisms such as wheels allowing for ready movement to a new location or different part of the tree or shrub or to adjacent tree or shrub so the same design can be applied consistently.

The shaped guide includes at least one elongated shaped member having at least a curved portion; and the connection mechanism including said movement elements allowing sliding or pivotal movement relative to the posts such that the shaped guide including the curved portion follows a shaped path. The elongated shaped member forms a partial circumference of a sphere and the connection mechanism including said movement elements allowing sliding or pivotal movement relative to the posts such that the shaped guide follows a substantially spherical shaped path. The shaped guide includes at least one exoskeletal shaped member forming a portion of the required shape of the tree or shrub and the connection mechanism of the shaped member to the support including said movement elements allowing sliding or pivotal movement relative to the support such that the shaped guide allows shaping of more than one portion of the tree or shrub than the shaped member covers in one position.

The shaped guide can include a plurality of comb-like slits to allow the shaped guide to follow a shaped path with parts of the tree or shrub to protrude through the slits and allow trimming thereof to shape the tree or shrub to the shaped path.

A plurality of the elongated shaped members can be mounted on the support and positionable adjacent the tree or bush and the elongated shaped members movable relative to the support around the tree or bush by said movement elements of the connection means to spaced positions to form an enclosing exoskeletal partial circumference of a shape and allowing a trimming of the tree or bush between the plurality of the elongated shaped members to form the virtual shape defined by the elongated shaped members.

The tree or shrub shaping guide can have the shaped guide mounted on the support with the connection means including movement elements allowing rotational movement relative to the support such that the shaped guide follows a curved path allowing shaping of more than one portion of the tree or shrub than the shaped member covers in one position.

A cutting mechanism such as an electric trimmer or the like can be mounted on the shaped guide and able to slide along or move relative to the guide to fulfil the required shaped cut on the tree or shrub.

The shaped guide should include at least one curve and the connection mechanism allows sliding or pivotal movement relative to the posts such that the shaped guide including the curve follows a shaped path. In this way, the guide allows for precise definition of shapes such as waves or balls. However, by the combination of various shaped guides and various movement elements and or movement mechanisms allows for definition of three dimensional shape.

The invention also provides a method of shaping a tree or shrub including the steps of:

(i) positioning a support adjacent the tree or shrub;

(ii) mounting one or more shaped guides on the support connection;

(iii) moving the one or more shaped guides adjacent the tree or shrub to define a virtual shape;

(iv) trimming the tree or shrub to the virtual shape; and preferably

(v) moving the shaped guides mounted on the support connection to a further location to allow further definition of the virtual shape and allow trimming of the tree or shrub to the virtual shape.

The moving of the shaped guides mounted on the support connection can be by movable connection of the shaped guides to the support whereby the movement of the shaped guides relative to the support defines a shaped portion to allow further definition of the virtual shape and allow trimming of the tree or shrub to the virtual shape.

The invention is primarily directed at a guide for use in manual cutting of the tree or shrub in order to fulfil the preciseness required in topiary. However the invention can also be directed at a mount for a cutting mechanism where an electric trimmer or the like is mounted on the shaped guide and can slide along or move relative to the guide to fulfil the required shaped cut on the tree or shrub.

In view of the foregoing described disadvantages inherent in the known types of portable tool alignment devices now present in the prior art, the present invention provides an improved shaping guide construction wherein the same can be utilized for employing visual feedback to control and maintain the angular disposition of a shaping blade when operationally disposed.

As such, the general purpose of the present invention, which will be described subsequently in detail, is to provide a new and improved shaping guide apparatus and method, which has advantages over the prior, art and minimises the disadvantages.

It should be appreciated by those skilled in the art that the conception and the disclosed specific methods and structures can be readily utilised as a basis for modifying or designing other structures for carrying out the same purposes of the present invention. It should be realised by those skilled in the art that such equivalent methods and structures do not depart from the spirit and scope of the invention and are included herein.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practised and carried out in various ways. Also, it is to be understood that the phraseology and terminology employed herein are for the purpose of description and should not be regarded as limiting.

The novel features that are considered characteristic of the invention are set forth with particularity in the appended claims. The invention itself, however, both as to its structure and its operation together with the additional object and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

In order that the invention is more readily understood and objects other than those set forth above will become apparent an embodiment will be described by way of illustration only with reference to the drawings wherein:

FIG. 1 is a front view of a first embodiment of a shaping guide in accordance with the invention showing the shaping guide located around a standard tree being shaped;

FIG. 2 is a side diagrammatic view of the shaping guide of FIG. 1 in a circular cut indicating position;

FIG. 3 is perspective view of the shaping guide of FIG. 1 separate from the tree;

FIG. 4 is a plan view of another form of the shaped semi circular curved guide of the shaping guide of FIG. 1;

FIG. 5 is a front view of a second embodiment of a shaping guide in accordance with the invention showing the shaping guide with a plurality of shaped semi circular curved guides located around a standard tree being shaped.

### DESCRIPTION OF THE PREFERRED EMBODIMENT OF THE INVENTION

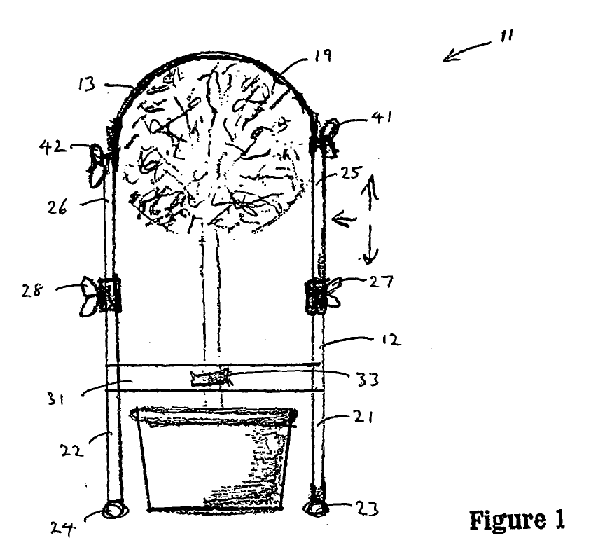

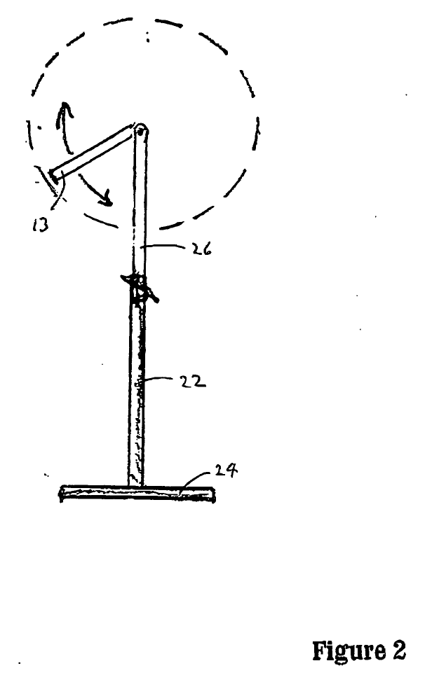

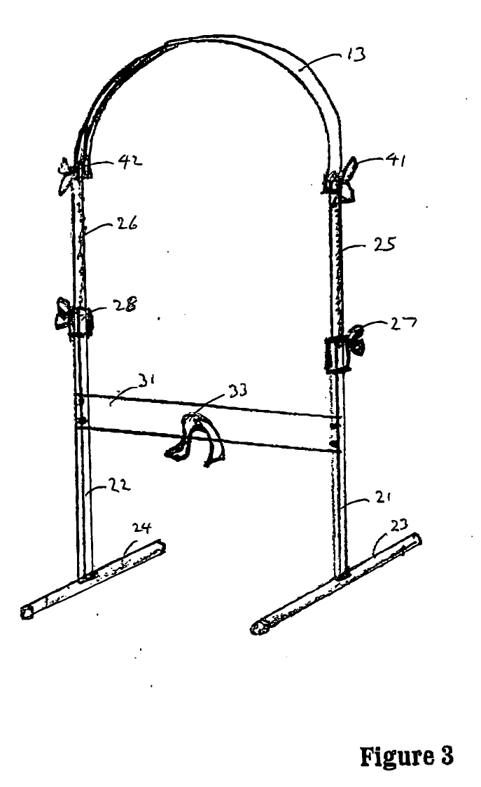

With reference to the drawings, and in particular to FIGS. 1 to 3, there is shown a tree or shrub shaping guide 11 including an elongated support 12 and a shaped substantially semi-circular curved guide 13.

The elongated support 12 has two spaced elongated linear vertically extending posts 21, 22 each with elongated linear feet 23, 24 that form an inverted T shape. The posts 21, 22 are telescopic each having co-linear telescopic elongated sections 25, 26 extending upwardly away from the feet 23, 24 and from telescopic locking joints 27, 28 which can lock the telescopic sections 25, 26 at the required height. The elongated support 12 can be positioned adjacent a tree or shrub to be shaped and has a linear cross member 31 between the posts 21, 22 for strength. The cross member 31 further including a restraint mechanism 32 in the form of a tie or loop and hook material and the restraint mechanism being substantially central such that it can fit around and be restrained at the trunk of the tree 19 to be shaped.

The shaped substantially semi-circular curved guide 13 is mounted by connection mechanisms 41, 42 connecting the shaped guide to the top of the telescopic sections 25, 26 of the elongated posts 21, 22. This allows the shaped guide 13 to move pivotally relative to the elongated support posts 21, 22 such that the shaped curve follows a ball shape around the tree or shrub 19. This path can be employed to enable a user to operate a cutting mechanism or secateurs or the like to shape a tree or shrub and particularly for guiding the user in the art of topiary.

In use the shaping guide allows shaping a tree or shrub including the steps of positioning a support adjacent the tree or shrub; mounting one or more shaped guides on the support connection; moving the one or more shaped guides adjacent the tree or shrub to define a virtual shape; trimming the tree or shrub to the virtual shape and moving the shaped guides mounted on the support connection to a further location to allow further definition of the virtual shape and allow trimming of the tree or shrub to the virtual shape. The moving of the shaped guides mounted on the support connection is by movable connection of the shaped guides to the support whereby the movement of the shaped guides relative to the support defines a shaped portion to allow further definition of the virtual shape and allow trimming of the tree or shrub to the virtual shape.

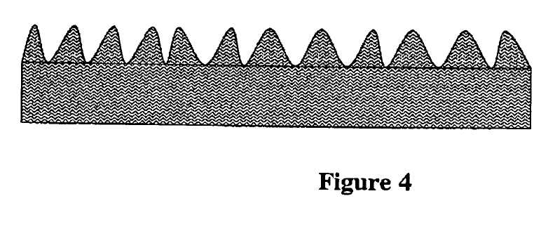

Referring to FIG. 4, there is shown another form of the shaped substantially semi-circular curved guide 13 in which the shaped guide includes a plurality of comb-like slits to allow the shaped guide to follow a shaped path with parts of the tree or shrub to protrude through the slits and allow trimming thereof to shape the tree or shrub to the shaped path.

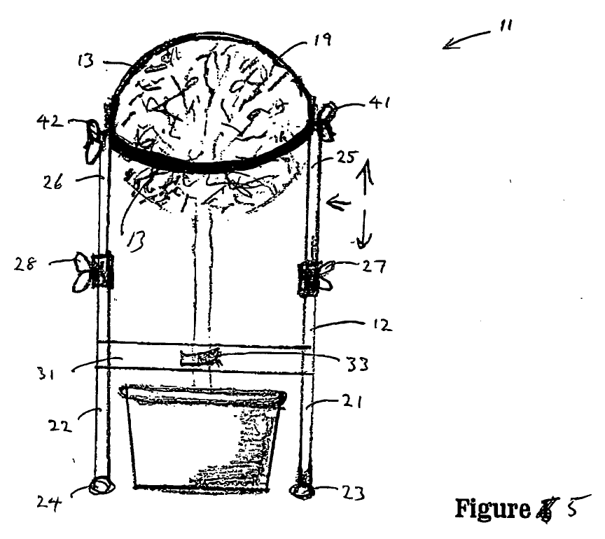

In another form of the invention, as shown in FIG. 5, there is a shaping guide with a plurality of shaped semi circular curved guides located around a standard tree being shaped. The plurality of the elongated shaped members are mounted on the support and positionable adjacent the tree or bush. The mounting is by movement elements of the connection mechanism that allows the elongated shaped members to move relative to the support around the tree or bush. The plurality of shaped semi circular curved guides can be moved to spaced positions to form an enclosing exoskeletal partial circumference of a shape and allowing a trimming of the tree or bush between the plurality of the elongated shaped members to form the virtual shape defined by the elongated shaped members.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents can be resorted to without departing from the spirit and scope of the invention.

For example the elongated support can be mounted on wheels to allow the shaping guide to proceed to adjacent trees or shrubs without adjustment and maintaining consistent shaping. Further the elongated support could be a single post. The restraining means could be used to maintain required distance from the trunk of fence or other structure. The curved guide at the top of the elongated posts could be able to move in defined curved paths in combination with pivotal movement or instead of the pivotal movement. In this way, a defined movement can form a defined shape.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

1. A tree or shrub shaping guide comprising:
an elongated support positionable adjacent an object to be shaped;
a shaped guide; and
a connection mechanism connecting the shaped guide to the elongated support, which comprises movement elements to allow the shaped guide to move relative to the elongated support;
wherein the shaped guide allows movement along a shaped path and enables a user to operate a cutting mechanism to shape an object.

2. The tree or shrub shaping guide according to claim 1 wherein the elongated support comprises an elongated telescopic post for adjusting the height of the guide dependent on the height of the object, said shaped guide being mounted on or near a top end of the elongated telescopic post.

3. The tree or shrub shaping guide according to claim 2 wherein the elongated support is mounted on a stand to enable steady unassisted location of the guide adjacent the object.

4. The tree or shrub shaping guide according to claim 3 wherein the stand further comprises movement mechanisms allowing for ready movement to a new location or different part of the object so the same design can be applied consistently.

5. The tree or shrub shaping guide according to claim 1 wherein the shaped guide comprises at least one elongated shaped member having at least a curved portion; and the connection mechanism further comprises movement elements allowing sliding or pivotal movement relative to the posts such that the shaped guide, including the curved portion, follows a shaped path.

6. The tree or shrub shaping guide according to claim 1 wherein the shaped guide further comprises a plurality of comb-like slits to allow the shaped guide to follow a shaped path with parts of the object to protrude through the slits and allow trimming thereof to shape the object to the shaped path.

7. The tree or shrub shaping guide according to claim 5 wherein the elongated shaped member forms a partial circumference of a sphere and the connection mechanism further comprises movement elements allowing sliding or pivotal movement relative to the telescopic posts such that the shaped guide follows a substantially spherical shaped path.

8. The tree or shrub shaping guide according to claim 5 comprising a plurality of the elongated shaped members mounted on the support and positionable adjacent the object and the elongated shaped members movable relative to the support around the object by said movement elements of the connection mechanism to spaced positions to form an enclosing exoskeletal partial circumference of a shape and allowing a trimming of the object between the plurality of the elongated shaped members to form the virtual shape defined by the elongated shaped members.

9. The tree or shrub shaping guide according to claim 1 wherein the shaped guide comprises at least one exoskeletal shaped member forming a portion of the required shape of the object and the connection mechanism of the shaped guide to the elongated support further comprising movement elements allowing sliding or pivotal movement relative to the elongated support such that the shaped guide allows shaping of more than one portion of the object than the shaped member covers in one position.

10. The tree or shrub shaping guide according to claim 9 wherein the shaped guide mounted on the elongated support with the connection mechanism further comprises movement elements allowing rotational movement relative to the support such that the shaped guide follows a curved path allowing shaping of more than one portion of the tree or shrub than the shaped member covers in one position.

11. The tree or shrub shaping guide according to claim 1 further comprising a cutting mechanism that is slideable along or moveable relative to the shaped guide.

12. A tree or shrub shaping guide comprising:
an elongated support comprising two spaced posts each with an elongated linear foot that forms an inverted T shape, the posts being telescopic and positionable adjacent an object to be shaped and having cross member extending between the two spaced posts for strength, the cross member further comprising a restraint mechanism substantially centrally located such that the restraint mechanism can fit around and be restrained an ojbect to be shaped;
a shaped substantially semi-circular curved guide mounted by a connection mechanism connecting the shaped guide to a top of the elongated posts and further comprising movement elements that allow the shaped guide to move pivotally relative to the elongated support such that the shaped guide follows a ball shape around the object and that is employable to enable a user to operate a cutting mechanism to shape the object.

13. A tree or shrub shaping guide comprising:
a support positionable adjacent an object to be shaped;
one or more shaped guides; and
a connection mechanism connecting the one or more shaped guides to the support;
wherein by the combination of various shaped guides connected to the support a shaped path is defined around the object that can be employed to enable a user to operate a cutting mechanism to shape the object.

14. The tree or shrub shaping guide according to claim 13 wherein the connection mechanism allows releasable connection of the one or more shaped guides to the support.

15. The tree or shrub shaping guide according to claim 13 wherein the connection mechanism allows releasable simultaneous connection of a plurality of the shaped guides.

16. The tree or shrub shaping guide according to claim 15 wherein the connection mechanism allows separate movement of the plurality of the shaped guides.

17. The tree or shrub shaping guide according to claim 15 wherein the connection mechanism comprises movement elements allowing separate movement of the plurality of the shaped guides and whereby the combination of various shaped guides and various movement elements and or movement elements allows for definition of a three dimensional shape.

18. The tree or shrub shaping guide according to claim 13 wherein the support comprises an elongated telescopic post for adjusting the height of the one or more shaped guides dependent on the height of the object and with the one or more shaped guides mounted on or near a top of the elongated telescopic post.

19. The tree or shrub shaping guide according to claim 18 wherein the elongated support is mounted on a stand to enable steady unassisted location of the one or more guides adjacent the object.

20. The tree or shrub shaping guide according to claim 19 wherein the stand comprises movement mechanisms allowing for ready movement to a new location or different part of the object so the same design can be applied consistently.

21. The tree or shrub shaping guide according to claim 13 wherein the one or more shaped guides comprises at least one elongated shaped guide having at least a curved portion; and the connection mechanism comprising movement elements allowing sliding or pivotal movement relative to the support such that the one or more shaped guides, including the at least one shaped guide with a curved portion, follows a shaped path.

22. The tree or shrub shaping guide according to claim 13 wherein the one or more shaped guides comprises a plurality of comb-like slits in at least one of the one or more shaped guides to allow the shaped guide to follow a shaped path with parts of the object to protrude through the slits and allow trimming thereof to shape the object to the shaped path.

23. The tree or shrub shaping guide according to claim 17 wherein the one or more shaped guides comprises at least an elongated shaped guide forming a partial circumference of a sphere and the connection mechanism comprises movement elements allowing sliding or pivotal movement relative to the supports such that the elongated shaped guide forming a partial circumference of a sphere follows a substantially spherical shaped path.

24. The tree or shrub shaping guide according to claim 17 wherein the one or more shaped guides comprises a plurality of elongated shaped guides mounted on the support and positionable adjacent the object and the elongated shaped guides movable relative to the support around the object by movement elements of the connection mechanism to spaced positions to form an enclosing exoskeletal partial circumference of a shape and allowing a trimming of the object between the plurality of the elongated shaped guides to form the virtual shape defined by the elongated shaped members.

25. The tree or shrub shaping guide according to claim 13 wherein the one or more shaped guides comprises at least one exoskeletal shaped guide forming a portion of a required shape of the object and the connection mechanism of the shaped member to the support comprising movement elements allowing sliding or pivotal movement relative to the support such that the shaped guide allows shaping of more than one portion of the object than the shaped member covers in one position.

26. The tree or shrub shaping guide according to claim 25 wherein the shaped guide mounted on the support with the connection mechanism including said movement elements allowing rotational movement relative to the support such that the shaped guide follows a curved path allowing shaping of more than one portion of the object than the shaped member covers in one position.

27. The tree or shrub shaping guide according to claim 13 further comprising a cutting mechanism mounted on at least one of the one or more shaped guides and slideable along or moveable relative to the guide to fulfil the required shaped cut on the object.

28. A method of shaping a tree or shrub comprising the steps of:
(i) positioning a support adjacent the tree or shrub;
(ii) mounting one or more shaped guides on the support;
(iii) moving the one or more shaped guides adjacent the tree or shrub to define a virtual shape;
(iv) trimming the tree or shrub to the virtual shape.

29. The method of shaping a tree or shrub according to claim 28 further comprising the step of moving the shaped guides mounted on the support connection to a further location to allow further definition of the virtual shape and allow trimming of the tree or shrub to the virtual shape.

30. The method of shaping a tree or shrub according to claim 29 wherein the moving of the shaped guides mounted on the support connection is by movable connection of the shaped guides to the support whereby the movement of the shaped guides relative to the support defines a shaped portion to allow further definition of the virtual shape and allow trimming of the tree or shrub to the virtual shape.
